(19) United States
(12) Patent Application Publication
(10) Pub. No.: US 2026/0208586 A1
(43) Pub. Date: Jul. 23, 2026

(54) IN-VEHICLE SYSTEM AND INFORMATION PROCESSING APPARATUS

(71) Applicant: TOYOTA JIDOSHA KABUSHIKI KAISHA, Toyota-shi (JP)

(72) Inventors: Tatsuya TANIZAWA, Nisshin-shi (JP); Akinori SHIN, Toyota-shi (JP); Junichi TODAKA, Seto-shi (JP); Kyosuke NAKANISHI, Setagaya-ku (JP); Hideo HASEGAWA, Nagoya-shi (JP)

(73) Assignee: TOYOTA JIDOSHA KABUSHIKI KAISHA, Toyota-shi (JP)

(21) Appl. No.: 19/447,514

(22) Filed: Jan. 13, 2026

(30) Foreign Application Priority Data
Jan. 21, 2025 (JP) 2025-008567

(51) Int. Cl. B60K 35/81; B60K 35/10; B60K 35/22; B60K 35/65; G06F 3/01; G06F 3/14

(52) U.S. Cl. CPC B60K 35/81; B60K 35/10; B60K 35/22; B60K 35/654; G06F 3/013; B60K 2360/1434; B60K 2360/16; B60K 2360/20; G06F 3/1423

(57) ABSTRACT

An in-vehicle system includes a display device and an information processing apparatus, wherein the display device includes a pair of display units that are provided in a forward portion of a driver's seat in a passenger compartment of a vehicle, are disposed at positions on both sides of a steering wheel while protruding rearward of an instrument unit disposed in front of the steering wheel, and have touch panels; and the information processing apparatus includes a controller configured to execute: turning off screens of the pair of display units in response to a predetermined condition being satisfied; and outputting, to a display device, information for activating a screen of a first display unit corresponding to a line-of-sight direction of a driver of the vehicle among the pair of display units whose screens are turned off.

### CROSS REFERENCE TO THE RELATED APPLICATION

This application claims the benefit of Japanese Patent Application No. 2025-008567, filed on January 21, 2025, which is hereby incorporated by reference herein in its entirety.

### BACKGROUND

### Technical Field

The present disclosure relates to an in-vehicle system and an information processing apparatus.

### Description of the Related Art

There has been known a vehicle including a plurality of displays (for example, refer to Patent Literature 1).

### Citation List

### Patent Literature

Patent Literature 1: Japanese Unexamined Patent Application Publication No. 2013-121805

Patent Literature 2: Japanese Unexamined Patent Application Publication No. 2017-097687

### SUMMARY

An object of the present disclosure is to display a more appropriate screen at a more appropriate timing.

One aspect of the present disclosure is directed to an in-vehicle system including a display device, and an information processing apparatus configured to output information via the display device,

the display device including a pair of display units that are provided in a forward portion of a driver's seat in a passenger compartment of a vehicle, are disposed at positions on both sides of a steering wheel while protruding rearward of an instrument unit disposed in front of the steering wheel, and have touch panels,

the information processing apparatus including a controller configured to execute:

turning off screens of the pair of display units in response to a predetermined condition being satisfied;

detecting a line-of-sight direction of a driver of the vehicle by a sensor when the screens of the pair of display units are turned off;

identifying a first display unit located in the line-of-sight direction of the driver of the vehicle from among the pair of display units whose screens are turned off; and

outputting information for activating a screen of the first display unit to the display device.

Another aspect of the present disclosure is directed to an in-vehicle system including a display device, and an information processing apparatus configured to output information via the display device,

the display device including a pair of display units that are provided in a forward portion of a driver's seat in a passenger compartment of a vehicle, are disposed at positions on both sides of a steering wheel while protruding rearward of an instrument unit disposed in front of the steering wheel, and have touch panels,

the information processing apparatus including a controller configured to execute:

turning off screens of the pair of display units in response to a predetermined condition being satisfied; and

outputting, to the display device, information for activating a screen of a first display unit corresponding to a line-of-sight direction of a driver of the vehicle among the pair of display units whose screens are turned off.

A further aspect of the present disclosure is directed to information processing apparatus configured to output information via a display device,

the display device including a pair of display units that are provided in a forward portion of a driver's seat in a passenger compartment of a vehicle, are disposed at positions on both sides of a steering wheel while protruding rearward of an instrument unit disposed in front of the steering wheel, and have touch panels,

the information processing apparatus including a controller configured to execute:

turning off screens of the pair of display units in response to a predetermined condition being satisfied; and

outputting, to the display device, information for activating a screen of a first display unit corresponding to a line-of-sight direction of a driver of the vehicle among the pair of display units whose screens are turned off.

In addition, other aspects of the present disclosure are directed to a vehicle equipped with the above-described in-vehicle system, an information processing method to be executed by the above-described information processing apparatus, a program for causing a computer to execute the information processing method, and a computer readable storage medium storing the program in a non-transitory manner.

According to the present disclosure, it is possible to display a more appropriate screen at a more appropriate timing.

### BRIEF DESCRIPTION OF THE DRAWINGS

FIG. 1 is a view illustrating a passenger compartment of a vehicle;

FIG. 2 is an enlarged view of surroundings of a steering wheel;

FIG. 3 is a diagram schematically illustrating an example of a hardware configuration of the vehicle;

FIG. 4 is a diagram illustrating an example of a functional configuration of an ECU;

FIG. 5 is a flowchart of processing related to screen sleep of an inner display or an outer display according to a first embodiment;

FIG. 6 is a diagram illustrating an example of a setting screen for headlights;

FIG. 7 is a flowchart of processing related to screen sleep of an inner display or an outer display according to a second embodiment;

FIG. 8 is a diagram illustrating an example of a setting screen for wipers;

FIG. 9 is a flowchart of processing related to screen sleep of an inner display or an outer display according to a third embodiment;

FIG. 10 is a diagram illustrating an example of a home screen of an inner display and a home screen of an outer display;

FIG. 11 is a flowchart of processing related to screen sleep of an inner display or an outer display according to a fourth embodiment;

FIG. 12 is an example of a screen corresponding to audio content; and

FIG. 13 is a flowchart of processing related to screen sleep of an inner display or an outer display according to a fifth embodiment.

### DESCRIPTION OF THE EMBODIMENTS

In recent years, as automobiles have become more sophisticated, the displays used to provide information are becoming larger, or the number of displays is increasing. For example, a method has been proposed in which a large-sized touch panel display is disposed between a driver's seat and a front passenger seat in a front portion of a passenger compartment, to collectively perform vehicle-related operations and information provision. However, in such a method, the line of sight of a driver moves significantly when the driver operates the components included in the vehicle or checking output information. For the driving safety of the vehicle, it is preferable to minimize the movement of the driver’s line of sight.

In contrast, an in-vehicle system according to one aspect of the present disclosure includes a display device and an information processing apparatus configured to output information via the display device, wherein the display device includes a pair of display units that are provided in a forward portion of a driver's seat in a passenger compartment, are disposed at positions on both sides of a steering wheel while protruding rearward of an instrument unit disposed in front of the steering wheel, and have touch panels.

The display device includes the pair of display units disposed at positions on both sides of the steering wheel. Also, the pair of display units are each configured to allow touch operations using a touch panel. The pair of display units are preferably disposed at positions protruding in the front and rear direction of the vehicle more toward the rear thereof than the instrument unit located in front of the steering wheel (typically, a meter panel where a speedometer is located), i.e., closer to the driver. By providing the pair of display units at such positions, it is possible to arrange the touch panels in the vicinity of the portions of the steering wheel held by the driver. In other words, it is possible to minimize the time that the driver has to release his/her hands from the steering wheel during operation. Note that the steering wheel does not necessarily have to be circular as long as it has a grip portion and is rotated to perform a steering operation.

The pair of display units presents, for example, information related to control of the vehicle or information related to convenience of occupants of the vehicle to a user. The information related to the convenience of the occupants of the vehicle may include information for providing entertainment to the occupants of the vehicle, information related to comfort of the occupants, or the like. The information related to the comfort and convenience of the occupants includes, for example, interfaces for operating audio, navigation, air conditioner, telephone, clock, voice assistant, etc., as well as information about the operating status of these devices. The information related to the control of the vehicle includes information about the driving or traveling of the vehicle. The information related to the control of the vehicle includes, for example, interfaces for operating headlights, wipers, side mirrors, ADAS (Advanced Driver Assistance System), drive mode, vehicle height, steering wheel position, seat position, etc., as well as information related to the operating status of these devices.

Here, if the pair of display units are kept constantly activated while the vehicle is traveling, there is a concern that power consumption may increase or the driver may feel dazzled. In contrast, a controller in the information processing apparatus turns off the screens of the pair of display units in response to a predetermined condition being satisfied. The predetermined condition may be, for example, that the user has not looked at the pair of display units for a certain period of time, or that the user has not operated the pair of display units for a certain period of time. On the other hand, it is troublesome for the driver to operate a touch panel or the like when the screen that has been turned off is to be activated (or restored).

Therefore, the controller of the information processing apparatus outputs, to the display device, information for activating a screen of a first display unit corresponding to a line-of-sight direction of a driver of the vehicle among the pair of display units whose screens are turned off. In this way, by automatically activating the first display unit disposed in the line-of-sight direction of the driver, the driver does not need to perform a separate operation to activate the screen. In addition, by activating the first screen when the driver looks at the first screen, a more appropriate screen can be displayed at a more appropriate timing.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

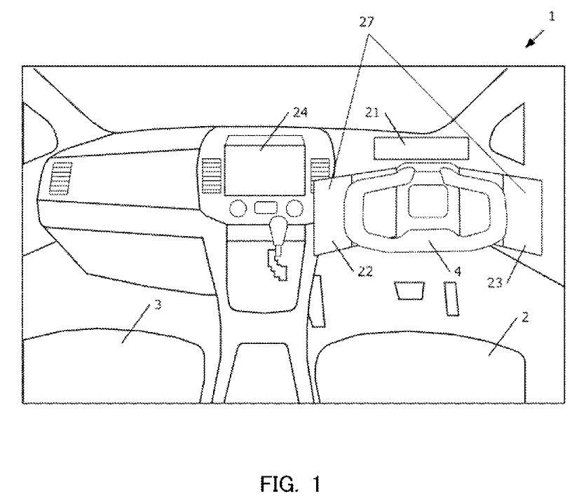

FIG. 1 is a view illustrating a passenger compartment of a vehicle 1. As illustrated in FIG. 1, a driver's seat 2 and a front passenger seat 3 are provided in the passenger compartment of the vehicle 1. Note that the vehicle 1 of the present first embodiment is a right-hand drive vehicle, and the driver's seat 2 is provided on the right side of the vehicle 1. A steering wheel 4 is disposed on the forward side of the driver's seat 2. Note that the steering wheel 4 may be circular or may be U-shaped (a so-called irregular steering wheel), as illustrated. The steering wheel 4 is connected to a steering device of the vehicle 1 via a steering column. The steering column is covered by a column cover.

The front passenger seat 3 is provided on the left side of the driver's seat 2, and a center display 24 is disposed on the front side of the vehicle at an intermediate position between the driver's seat 2 and the front passenger seat 3. The center display 24 displays, for example, auxiliary information such as car navigation, or contents related to entertainment such as audio and television.

A meter display 21 is provided on the vehicle front side of the steering wheel 4. The meter display 21 is a full-screen display that is positioned in front of the driver's seat 2 to provide various types of information to the driver of the vehicle 1. The meter display 21 displays information necessary for driving the vehicle such as, for example, a speed of the vehicle (vehicle speed), an engine speed (if the vehicle 1 has an engine), a charge and discharge condition (if the vehicle 1 has a drive battery), and a travel distance. The meter display 21 is an example of a “meter unit” in the present disclosure.

A pair of display devices 27 are provided in a forward portion of the driver's seat 2 of the passenger compartment. The pair of display devices 27 includes touch panel displays respectively disposed at positions on both sides of the steering wheel 4. In the present embodiment, a display disposed closer to the inner side of the vehicle is referred to as an inner display 22, and a display disposed closer to the outer side of the vehicle is referred to as an outer display 23. The inner display 22 and the outer display 23 are connected to an instrument panel of the vehicle 1.

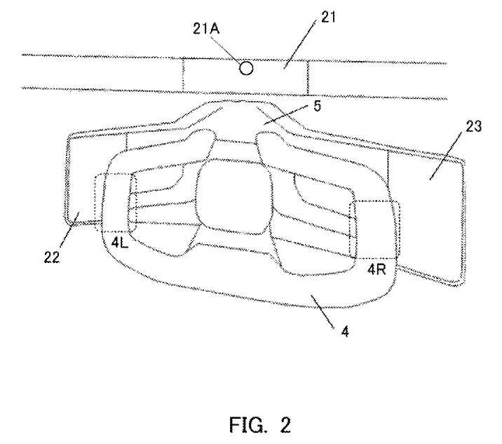

Referring to FIG. 2, the detailed structures of the inner display 22 and the outer display 23 will be described. FIG. 2 is an enlarged view of surroundings of the steering wheel 4. The inner display 22 and the outer display 23 are vertically long displays, and are connected to a support portion 5 which is a member supporting each display. The support portion 5 has a shape protruding in the left and right direction of the steering wheel 4. The outer display 23 is connected to the right end of the support portion 5 when facing the vehicle front side, and the inner display 22 is connected to the left end thereof when facing the vehicle front side. Accordingly, the display screens can be located in the vicinity of grip portions of the steering wheel 4.

Here, note that the above description is an example in the case where the vehicle 1 is a right-hand drive vehicle, whereas in the case where the vehicle 1 is a left-hand drive vehicle, the left and right sides are reversed. That is, the outer display 23 is connected to the left end of the support portion 5 when facing the front side of the vehicle, and the inner display 22 is connected to the right end of the support portion 5 when facing the front side of the vehicle.

The support portion 5 may also serve as a column cover that covers the steering column. The support portion 5 extends in the left and right direction (vehicle width direction) from its portion through which the steering column passes, and each of its left and right portions extends toward the vehicle rear side and is bent in its middle so that the angle thereof with respect to the left and right direction of the steering wheel becomes smaller.

Further, the inner display 22 and the outer display 23 are angled with respect to the left and right direction of the steering wheel 4, and are each disposed so as to be inclined toward the steering wheel side. That is, the inner display 22 is disposed to protrude more toward the rear of the vehicle 1 the more it is inside the vehicle 1, and the outer display 23 is disposed to protrude more toward the rear of the vehicle 1 the more it is outside the vehicle 1. In this manner, the inner display 22 and the outer display 23 are each disposed so as to face the driver.

An area 4R indicated by a broken line in FIG. 2 is a portion (grip portion) where the steering wheel 4 is gripped or held by the right hand, and an area 4L indicated by a broken line in FIG. 2 is a portion (grip portion) where the steering wheel 4 is gripped or held by the left hand. The inner display 22 and the outer display 23 are disposed closer to the vehicle front side than the grip portions of the steering wheel 4 in the front and rear direction of the vehicle 1. By forming the support portion 5 in the above- described shape, the positions of the inner display 22 and the outer display 23 in the vehicle front and rear direction can be brought closer to the grip portions of the steering wheel 4. Therefore, it is possible to further reduce the amount of hand movement when the driver performs a touch operation on the inner display 22 or the outer display 23 during driving.

The meter display 21, the inner display 22, and the outer display 23 are all displays each having a touch panel. Here, it is sufficient that at least the inner display 22 and the outer display 23 each have a touch panel. As a touch panel, for example, a touch panel of a pressure-sensitive type that detects a pressure applied to the panel by the user, a touch panel of an electrostatic capacitance type that detects a change in electrostatic capacitance when the user presses the panel, or the like can be adopted. The displays are each, for example, an LCD (Liquid Crystal Display), EL (Electroluminescence) panel, or the like. Note that in the following, when a user touches a screen, it means that the user touches a touch panel. A camera 21A facing the rear of the vehicle is arranged on the meter display 21. The camera 21A is a device that captures images by using an imaging element such as for example a CCD (Charge Coupled Device) image sensor, a CMOS (Complementary Metal Oxide Semiconductor) image sensor or the like. The images thus obtained by imaging may be either still images or moving images. The camera 21A is arranged so as to be able to capture an image of at least the vicinity of the eyes of the driver. Note that the arrangement of the camera 21A is not limited thereto, and the camera 21A may be arranged so as to be able to obtain the direction of the line of sight of the driver. For example, the camera may be arranged on the inner display 22 or the outer display 23, or it may be arranged on the support portion 5.

The inner display 22 displays, for example, information related to the convenience of occupants of the vehicle 1. The information related to the convenience of the occupants of the vehicle 1 includes information for providing entertainment to the occupants of the vehicle 1. The information related to the convenience of the occupants of the vehicle 1 may include information related to the comfort of the occupants. The information related to the comfort and convenience of the occupants includes, for example, information about switches, buttons, etc., for operating audio, navigation device, air conditioner, telephone, clock, voice assistant, etc., and information about the operating status of these devices.

The outer display 23 displays, for example, information related to the control of the vehicle 1. The information related to the control of the vehicle 1 includes information related to the driving or traveling of the vehicle 1. Specifically, the information related to the control of vehicle 1 includes, for example, information about switches, buttons, etc., for operating headlights, wipers, side mirrors, ADAS, drive mode, suspension, steering wheel position, and seat position, as well as information about the operating status of these devices. By displaying the information related to the control of the vehicle 1 on the outer display 23, it is possible to prevent passengers other than the driver from operating the information related to the control of the vehicle 1.

Here, note that the information to be displayed on the inner display 22 and the outer display 23 is not limited to the above. The inner display 22 may display information related to the control of the vehicle 1, and the outer display 23 may display information related to the convenience of the occupants of the vehicle 1. In addition, information to be displayed on the inner display 22 and the outer display 23 can be determined in an optional manner.

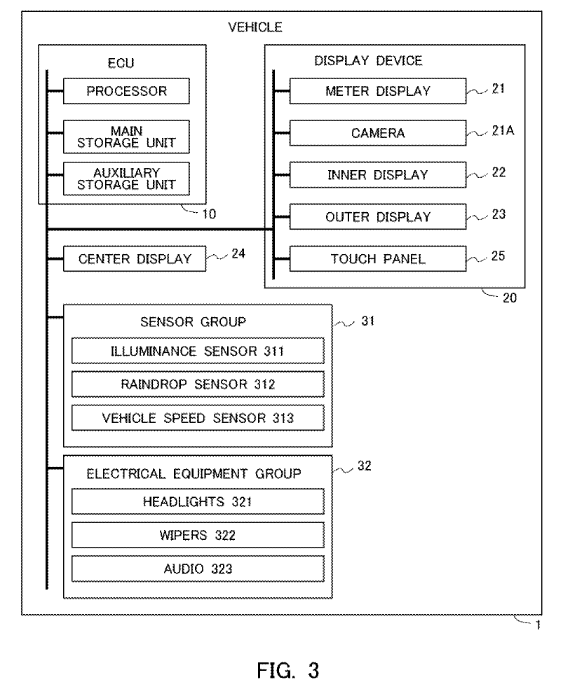

FIG. 3 is a diagram schematically illustrating an example of a hardware configuration of the vehicle 1. The vehicle 1 includes an ECU 10, a display device 20, the center display 24, a sensor group 31, and an electrical equipment group 32. The ECU 10 can be configured as a computer having a processor (CPU, GPU or the like), a main storage device (RAM, ROM, or the like), and an auxiliary storage device (EPROM, hard disk drive, removable medium, or the like). An operating system (OS), various programs, various tables, etc., are stored in the auxiliary storage device, and by executing the programs stored therein, it is possible to realize each function (software module) that meets a predetermined purpose, as will be described later. However, some or all of the functions may be realized as a hardware module by a hardware circuit such as, for example, an ASIC, an FPGA or the like. The display device 20, the center display 24, the sensor group 31, and the electrical equipment group 32 are connected to the ECU 10. The ECU 10 is an example of an information processing apparatus.

The display device 20 includes the meter display 21, the camera 21A, the inner display 22, the outer display 23, and a touch panel 25. The touch panel 25 is a unit for detecting touch operations performed on the meter display 21, the inner display 22, and the outer display 23. The meter display 21, the inner display 22, and the outer display 23 are each provided with the touch panel 25, so that they can be operated by touch.

The sensor group 31 is a set of a plurality of sensors for obtaining sensor data used in driving the vehicle 1. The sensors may obtain physical quantities or may obtain image data or the like. The sensor group 31 includes, for example, a sensor that detects the state of the vehicle 1, a sensor that detects the action or motion of the driver, and the like. The sensor group 31 includes, for example, an illuminance sensor 311 that detects the illuminance outside the vehicle 1, a raindrop sensor 312 that detects raindrops, a vehicle speed sensor 313 that detects the speed of the vehicle 1, an acceleration sensor that detects the acceleration of the vehicle 1, an accelerator opening sensor that detects the position of an accelerator pedal, a brake sensor that detects the position of a brake pedal, a steering angle sensor that detects the angle of a steering wheel, an engine rotation speed sensor that detects the rotation speed of an engine, a water temperature sensor that detects the temperature of engine cooling water, an oil temperature sensor that detects the temperature of engine oil, an oil pressure sensor that detects the pressure of engine oil, a sensor that detects the pressure of intake air of the engine, a yaw rate sensor, a winker switch sensor (a sensor that detects the state of a direction indicator switch), a shift position sensor, a position information sensor (GPS sensor), a sensor that detects the temperature inside the vehicle, a sensor that detects the temperature outside the vehicle, a radar that measures the distance to an object, etc.

The electrical equipment group 32 is a collection of electrical equipment used in the vehicle 1. The electrical equipment group 32 includes, for example, an air conditioner, a suspension, a massage seat, a navigation device, headlights 321, wipers 322, an audio system 323, a telephone, side mirrors, and a voice assistant.

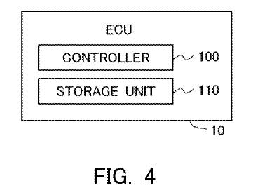

FIG. 4 is a diagram illustrating an example of a functional configuration of the ECU 10. The ECU 10 includes a controller 100 and a storage unit 110 as functional components. The controller 100 is a functional component provided, for example, by a processor executing various programs stored in an auxiliary storage unit. The storage unit 110 is a means for storing information, and is configured to include a main storage unit and the auxiliary storage unit.

The controller 100 puts the pair of display devices 27 into a sleep state when the driver does not access the pair of display devices 27 for a predetermined period of time. The driver not accessing the pair of display devices 27 for the predetermined period of time includes the driver not looking at the pair of display devices 27. That is, when the driver does not look at the display devices 27 for the predetermined period of time, the controller 100 may put the pair of display devices 27 into the sleep state. This sleep state includes turning off the screen. In addition, even when the pair of display devices 27 are in the sleep state, the touch panel 25 may still function. The predetermined period of time is a period of time during which it is considered that the driver does not use the pair of display devices 27, and is, for example, a period of time between five seconds and thirty seconds. Here, note that as the predetermined period of time is shorter, power consumption due to the lighting of the displays can be reduced and dazzling can be suppressed, but if the predetermined period of time is too short, it may be inconvenient for the user. Therefore, the predetermined period of time may be set in consideration of these factors. In addition, the predetermined period of time may be able to be set by the user. The information on the predetermined period of time is stored in the storage unit 110. The controller 100 may wake up or return the screens of the pair of display devices 27 when the user touches the screens of the pair of display devices 27 while they are in the sleep state.

In addition, when the pair of display devices 27 is in the sleep state, the controller 100 determines, based on the image captured by the camera 21A, whether or not the driver has looked at the pair of display devices 27. At this time, the controller 100 estimates the line-of-sight direction of the driver based on the image captured by the camera 21A. For this estimation, a known technique can be used. For example, the line-of-sight direction may be estimated from a relative positional relationship between an inner corner of an eye and its iris. In addition, for example, a method may be used in which a detected pupil contour is approximated by an ellipse to estimate the line-of-sight direction. Also, the line-of-sight direction may be estimated using machine learning. Then, it is determined whether or not the inner display 22 or the outer display 23 is present in the line-of-sight direction of the driver. At this time, the controller 100 makes a determination based on the positions of the eyes of the driver, the line-of-sight direction of the driver, and the positions of the inner display 22 and the outer display 23.

Moreover, when the controller 100 determines that the driver has looked at the inner display 22 or the outer display 23 while the pair of display devices 27 are in the sleep state, the controller 100 restores or returns the screen of the inner display 22 or the outer display 23 that the driver is looking at. Note that at this time, it may be a condition that the driver has looked at the pair of display devices 27 for the predetermined period of time or more. The predetermined period of time is a period of time indicating that the driver intends to use the pair of display devices 27. The predetermined period of time may be optionally set by the driver. When restoring the screen, the controller 100 may restore the screen displayed immediately before the sleep state, for example. In addition, the controller 100 may determine the screen to be restored according to the state of the vehicle 1 at that time and/or the external conditions outside the vehicle 1. Further, the controller 100 may display different screens depending on whether the vehicle 1 is stopped or traveling, or may display different screens depending on the speed of the vehicle 1.

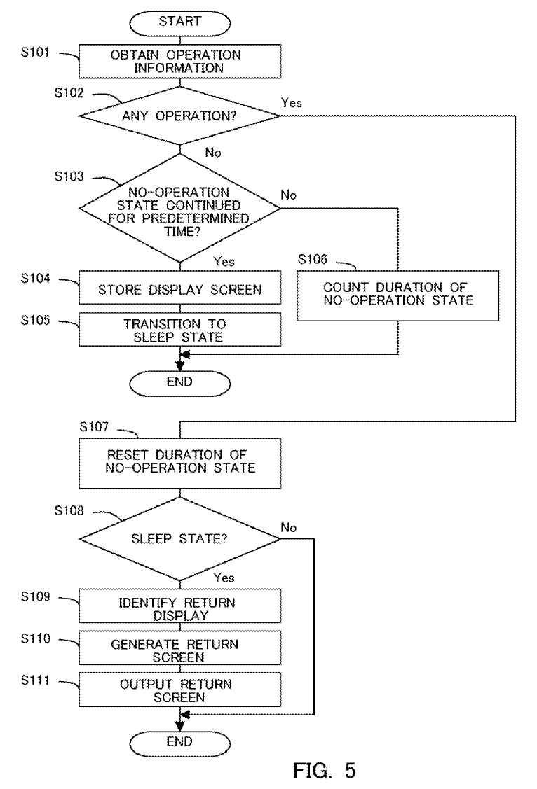

FIG. 5 is a flowchart of processing related to screen sleep of the inner display 22 or the outer display 23 according to the first embodiment. The processing illustrated in FIG. 5 is executed in the ECU 10 at predetermined time intervals.

In step S101, the controller 100 obtains, from the storage unit 110, operation information for determining whether or not the user has operated the pair of display devices 27. The operation information includes information regarding whether or not the user has touched the touch panel 25 and information regarding whether or not the user has looked at the inner display 22 or the outer display 23. The controller 100 obtains, for example, an output signal of the touch panel 25 or an output signal from the camera 21A. These signals may be stored in the storage unit 110.

In step S102, the controller 100 determines whether or not the user has performed an operation on the pair of display devices 27. The controller 100 determines that the user has operated the pair of display devices 27, for example, when detecting, based on a signal from the touch panel 25, that the user has touched the inner display 22 or the outer display 23. Also, the controller 100 may determine, based on an image captured by the camera 21A, whether or not the user has looked at the inner display 22 or the outer display 23. Then, when determining that the user has looked at the inner display 22 or the outer display 23, the controller 100 determines that the user has operated the pair of display devices 27. If the controller 100 makes an affirmative determination in step S102, the processing proceeds to step S107, whereas when the controller 100 makes a negative determination, the processing proceeds to step S103.

In step S103, the controller 100 determines whether or not a state in which no user operation has been performed on the pair of display devices 27 (hereinafter also referred to as a no-operation state) has continued for a predetermined period of time or more. This predetermined period of time is a period of time during which it is considered that the user does not need the screen display of the pair of display devices 27. The duration of the no-operation state is counted by the controller 100 in step S106. If the controller 100 makes an affirmative determination in step S103, the processing proceeds to step S104, whereas when the controller 100 makes a negative determination, the processing proceeds to step S106.

In step S104, the controller 100 stores in the storage unit 110 information about the screens currently being displayed on the pair of display devices 27. That is, the controller 100 stores in the storage unit 110 information about the screens immediately before the sleep state is entered. The information about the screens may include information that can identify the content displayed. Further, in step S105, the controller 100 causes the pair of display devices 27 to transition to the sleep state. Thus, the screens are turned off. At this time, the controller 100 may generate screens such that nothing is displayed on the inner display 22 and the outer display 23. For example, the controller 100 may generate screens that are entirely painted in black, or may generate a command to stop outputting screens to the inner display 22 and the outer display 23. The controller 100 may transmit, to the display device 20, a command to display screens that are entirely painted in black, or may transmit, to the display device 20, a command to turn off the screens of the inner display 22 and the outer display 23. When the sleep state is entered, the controller 100 causes the storage unit 110 to store information that can determine the transition to the sleep state. When the process of step S105 is completed, this routine ends.

In step S107, the controller 100 resets the count value for the duration of the no-operation state. Next, in step S108, the controller 100 determines whether or not the pair of display devices 27 are in the sleep state. Information regarding whether or not the pair of display devices 27 are in the sleep state is stored in the storage unit 110. If the controller 100 makes an affirmative determination in step S108, the processing proceeds to step S109, whereas if the controller 100 makes a negative determination, the routine ends.

In step S109, the controller 100 identifies a display whose screen is to be waked up (returned). The controller 100 identifies a display that the driver has looked at or a display that the driver has looked at for the predetermined period of time or more. This identification is performed based on the operation information obtained by the controller 100 in step S101.

In step S110, the controller 100 generates a wake-up or return screen from the sleep state. The controller 100 generates a screen, for example, according to the information stored in the storage unit 110 in step S104, so that the same content as that displayed immediately before the sleep state was entered is displayed. In step S111, the return screen thus generated is transmitted to the display device 20. At this time, the controller 100 may transmit, to the display device 20, a command to display the return screen on the display identified in step S109.

As described above, according to the present embodiment, it is possible to return the screen according to the line of sight of the user. Also, only a necessary display can be made to function according to the line-of-sight direction of the user. In this way, it is possible to display a more appropriate screen at a more appropriate timing. In addition, since unnecessary displays can be turned off, it is possible to reduce power consumption and suppress dazzling.

### Second Embodiment

In the first embodiment, the return screen is a screen corresponding to the content that was displayed immediately before the sleep state was entered. On the other hand, in a second embodiment, another mode of the return screen will be described. The controller 100 may change a screen at the time of activation according to the darkness outside the vehicle 1, for example. For example, when the illuminance detected by the illuminance sensor 311 included in the sensor group 31 is less than a predetermined illuminance, the controller 100 may activate a screen while displaying a setting screen for the headlights 321 on the pair of display devices 27. The illuminance is an example of a predetermined display condition.

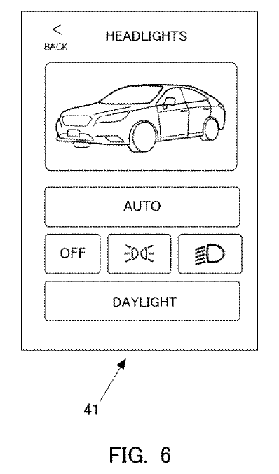

FIG. 6 is a diagram illustrating an example of a setting screen 41 for the headlights 321. The setting screen 41 for the headlights 321 is a screen for setting the lighting state of the headlights 321 included in the vehicle 1. The setting screen 41 for the headlights 321 allows the user to select the lighting state of the headlights 321 (automatic, on, off, small light, daylight, etc.). The controller 100 controls the headlights 321 based on the touch operation of the user. In addition, the controller 100 may reflect the lighting state of the headlights 321 on the setting screen 41 for the headlights 321. For example, the controller 100 may reflect the current lighting state of the headlights 321 in the graphic of the vehicle 1 drawn on the screen. The controller 100 generates the setting screen 41 for the headlights 321 illustrated in FIG. 6 and outputs the setting screen 41 to the display device 20.

Note that the setting screen 41 for the headlights 321 is normally displayed on the outer display 23. For example, when the driver selects the setting screen 41 for the headlights 321 from a menu screen displayed on the outer display 23, the controller 100 causes the outer display 23 to display the setting screen 41 for the headlights 321. However, only when the driver looks at the inner display 22 and its screen is activated, the controller 100 may display the setting screen 41 for the headlights 321 on the inner display 22. In addition, for example, only when the driver looks at the outer display 23 and its screen is activated, the controller 100 may display the setting screen 41 for the headlights 321 on the outer display 23.

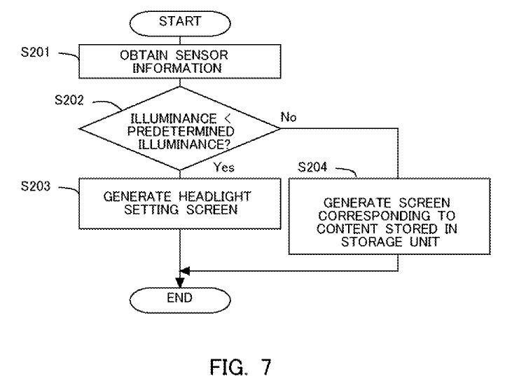

FIG. 7 is a flowchart of processing related to screen sleep of the inner display 22 or the outer display 23 according to the second embodiment. The processing illustrated in FIG. 7 is executed by the controller 100 in step S110 illustrated in FIG. 5. In step S201, the controller 100 obtains sensor information. At this time, the controller 100 obtains a detection value of the illuminance sensor 311 included in the sensor group 31. Next, in step S202, the controller 100 determines whether or not the illuminance thus detected is less than a predetermined illuminance. The predetermined illuminance is a lower limit value of the illuminance at which it is not necessary to turn on the light. The predetermined illuminance is stored in the storage unit 110. If the controller 100 makes an affirmative determination in step S202, the processing proceeds to step S203, whereas when the controller 100 makes a negative determination, the processing proceeds to step S204.

In step S203, the controller 100 generates the setting screen 41 for the headlights 321. On the other hand, in step S204, the controller 100 generates a screen according to the information stored in the storage unit 110 in step S104 so that the same content as that displayed immediately before the screen sleep is displayed. When the process of step S203 or step S204 is completed, the processing proceeds to step S111 illustrated in FIG. 5.

As described above, according to the present embodiment, the controller 100 can provide information required by the user in an appropriate manner.

### Third Embodiment

In a third embodiment, another mode of the return screen will be described. The controller 100 may change the screen at the time of activation according to, for example, rainfall. For example, when raindrops are detected by the raindrop sensor 312 included in the sensor group 31, the controller 100 may activate a screen while displaying a setting screen for the wipers 322 on the pair of display devices 27. The rainfall is an example of a predetermined display condition.

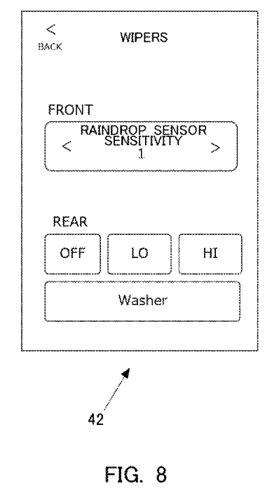

FIG. 8 is a diagram illustrating an example of the setting screen 42 for the wipers 322. The wipers 322 include a front wiper and a rear wiper. The setting screen 42 for the wipers 322 allows the user to select the operation state (stop, automatic operation, intermittent operation, continuous operation, or the like) of the wipers 322. The controller 100 controls the wipers 322 based on the touch operation of the user. In addition, the controller 100 may reflect the operation state of the wipers 322 on the setting screen 42 for the wipers 322. For example, the controller 100 may reflect the current operating state of the wipers 322 in the graphic of the vehicle 1 drawn on the screen. The controller 100 generates the setting screen 42 for the wipers 322 illustrated in FIG. 8 and outputs the setting screen 42 to the display device 20.

Note that the setting screen 42 for the wipers 322 is normally displayed on the outer display 23. For example, when the driver selects the setting screen 42 for the wipers 322 from a menu screen displayed on the outer display 23, the controller 100 causes the outer display 23 to display the setting screen 42 for the wipers 322. However, only when the driver looks at the inner display 22 and its screen is activated, the controller 100 may display the setting screen 42 for the wipers 322 on the inner display 22. In addition, for example, only when the driver looks at the outer display 23 and its screen is activated, the controller 100 may display the setting screen 42 for the wipers 322 on the outer display 23.

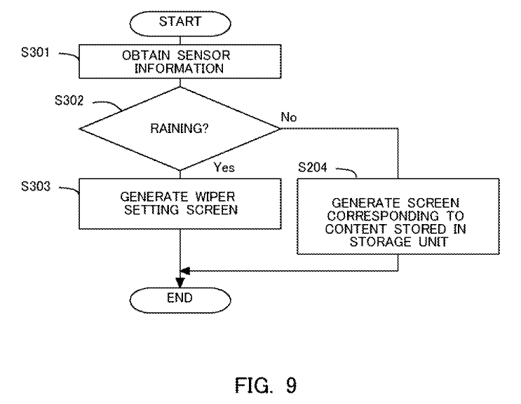

FIG. 9 is a flowchart of processing related to screen sleep of the inner display 22 or the outer display 23 according to the third embodiment. The processing illustrated in FIG. 9 is executed by the controller 100 in step S110 illustrated in FIG. 5. The same processes as those in the routine illustrated in FIG. 7 are denoted by the same reference signs, and the description thereof will be omitted. In step S301, the controller 100 obtains sensor information. At this time, the controller 100 obtains a detection value of the raindrop sensor 312 included in the sensor group 31. Next, in step S302, the controller 100 determines, based on the detection value of the raindrop sensor 312, whether or not it is raining. When raindrops are detected by the raindrop sensor 312, the controller 100 determines that it is raining. If the controller 100 makes an affirmative determination in step S302, the processing proceeds to step S303, whereas when the controller 100 makes a negative determination, the processing proceeds to step S204. In step S303, the controller 100 generates the setting screen 42 for the wipers 322. When the process of step S303 or step S204 is completed, the processing proceeds to step S111 illustrated in FIG. 5.

As described above, according to the present embodiment, the controller 100 can provide information required by the user in an appropriate manner.

### Fourth Embodiment

In step S110 in the first embodiment, in step S204 in the second embodiment, and in step S204 in the third embodiment, the return screen is a screen corresponding to the content immediately before the sleep state was entered. On the other hand, in a fourth embodiment, another mode of the return screen will be described. The controller 100 may, for example, activate screens while displaying home screens on the pair of display devices 27.

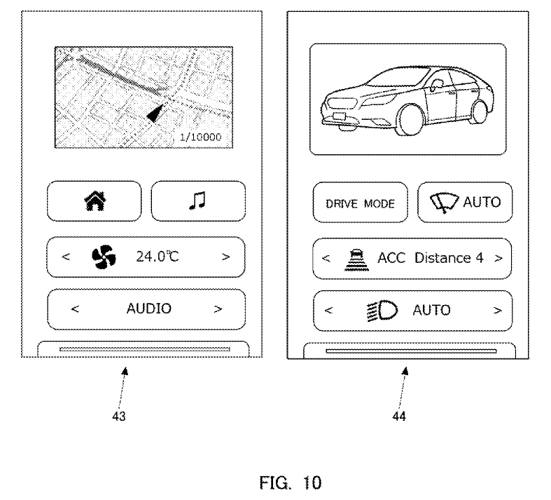

FIG. 10 is a diagram illustrating an example of a home screen 43 of the inner display 22 and a home screen 44 of the outer display 23. The home screen 43 of the inner display 22 is a screen that is normally displayed on the inner display 22 while the vehicle is driving. The home screen 44 of the outer display 23 is a screen that is normally displayed on the outer display 23 while the vehicle is driving. The display contents of the home screen 43 of the inner display 22 and the home screen 44 of the outer display 23 can be customized by the user. On the home screen 43 of the inner display 22, for example, shortcuts to content related to the convenience of the occupants of the vehicle 1, the operation state of the electrical equipment group 32, and the like are displayed. On the home screen 44 of the outer display 23, for example, shortcuts to content related to the control of the vehicle 1, the operation state of the electrical equipment group 32, and the like are displayed. The controller 100 generates the home screen 43 of the inner display 22 and the home screen 44 of the outer display 23 illustrated in FIG. 10, and outputs the home screens to the display device 20.

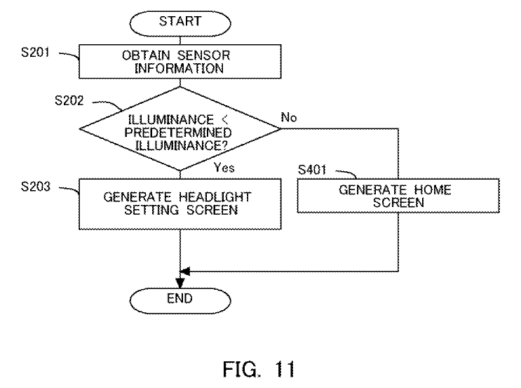

FIG. 11 is a flowchart of processing related to screen sleep of the inner display 22 or the outer display 23 according to the fourth embodiment. The processing illustrated in FIG. 11 is executed by the controller 100 in step S110 illustrated in FIG. 5. The same processes as those in the routine illustrated in FIG. 7 are denoted by the same reference signs, and the description thereof will be omitted. In the flowchart illustrated in FIG. 11, if the controller 100 makes an affirmative determination in step S202, the processing proceeds to step S203, whereas when the controller 100 makes a negative determination, the processing proceeds to step S401.

In step S401, the controller 100 generates a home screen. The home screen generated at this time is a home screen corresponding to one of the inner display 22 and the outer display 23 identified in step S109. Note that the controller 100 may execute the process of step S401 described above, instead of step S110 of the flowchart illustrated in FIG. 5. In addition, the controller 100 may execute the process of step S401 described above, instead of step S204 of the flowchart illustrated in FIG. 9.

As described above, according to the present embodiment, the controller 100 can provide information required by the user in an appropriate manner.

### Fifth Embodiment

In the present fifth embodiment, the return screen is changed according to the speed of the vehicle 1. Here, the higher the speed of the vehicle 1, the smaller the amount of information that the user can grasp when looking at the pair of display devices 27. Therefore, the controller 100 reduces the amount of information to be displayed on the screen at the time of activation as the speed of the vehicle 1 increases. Note that the speed of the vehicle 1 includes 0. That is, when the vehicle 1 is traveling, the amount of information displayed on the screen at the time of activation may be smaller than that at the time of stop. The vehicle speed is an example of a predetermined display condition. Note that the amount of information may be treated as increasing according to, for example, the number of pixels displaying figures or characters different from the background, the number of GUI components displayed, the number of operable GUI components, the number of characters displayed, the number of figures displayed, or the like.

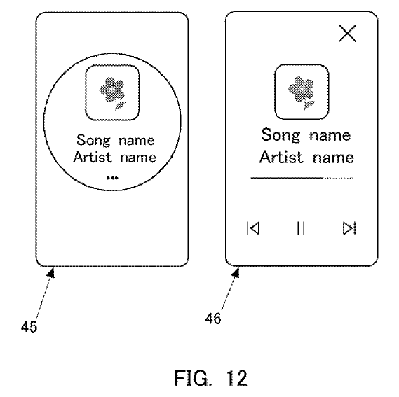

Hereinafter, an example will be described in which the content displayed immediately before entering the sleep state was audio content. FIG. 12 is an example of screens corresponding to audio content. Reference numeral 45 denotes a case where the amount of information is small, and reference numeral 46 denotes a case where the amount of information is large. The screen 45 with a small amount of information displays an image corresponding to a song title, the song title, and an artist name, whereas the screen 46 with a large amount of information further displays a time bar, a skip button, and a stop button, in addition to those shown in the screen 45. The controller 100 generates one of the screen 45 with a small amount of information and the screen 46 with a large amount of information illustrated in FIG. 12 according to the speed of the vehicle 1, and outputs the screen thus generated to the display device 20.

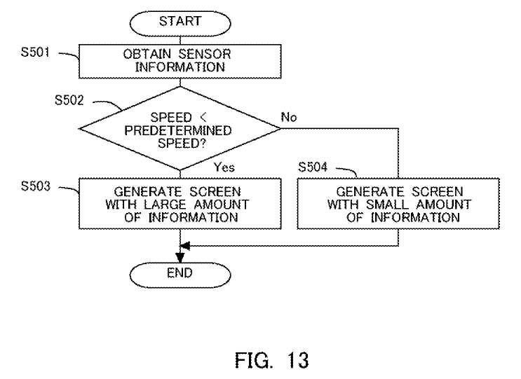

FIG. 13 is a flowchart of processing related to screen sleep of the inner display 22 or the outer display 23 according to the fifth embodiment. The processing illustrated in FIG. 13 is executed by the controller 100 in step S110 illustrated in FIG. 5. In step S501, the controller 100 obtains sensor information. At this time, the controller 100 obtains a detection value of the vehicle speed sensor 313 included in the sensor group 31. Next, in step S502, the controller 100 determines whether or not the detected speed of the vehicle 1 is less than a predetermined speed. The predetermined speed is a lower limit value of the speed at which the driver cannot grasp the information displayed on the pair of display devices 27 when the amount of information displayed is relatively large. The predetermined speed is stored in the storage unit 110. The predetermined speed may be set by the user. In addition, as another example, in step S502, the controller 100 may determine whether or not the vehicle 1 is stopped. If the controller 100 makes an affirmative determination in step S502, the processing proceeds to step S503, whereas when the controller 100 makes a negative determination, the processing proceeds to step S504.

In step S503, the controller 100 generates a screen with relatively large amount of information. On the other hand, in step S504, the controller 100 generates a screen with a relatively small amount of information. In this case, the screens are generated so that the display contents of the screen generated in step S504 are smaller than those of the screen generated in step S503. Note that the controller 100 may execute the processing illustrated in FIG. 13, respectively, instead of steps S203 and S204 of the flowchart illustrated in FIG. 7. Also, the controller 100 may execute the processing illustrated in FIG. 13, respectively, instead of steps S303 and S204 in the flowchart illustrated in FIG. 9. In addition, the screen at the time of activation is not limited to the screen corresponding to the audio content. For example, in a case where route guidance is displayed as content, a screen indicating the position of the own vehicle on a map may be displayed as the screen with a large amount of information, and a screen indicating the distance to the next right or left turn may be displayed as the screen with a small amount of information.

As described above, according to the present embodiment, the controller 100 can provide information required by the user in an appropriate manner.

### Other Embodiments

The above embodiments are merely examples, but the present disclosure can be implemented with appropriate modifications without departing from the spirit thereof. The processing and/or means (devices, units, etc.) described in the present disclosure can be freely combined and implemented as long as no technical contradiction occurs. In addition, the processing described as being performed by one device or unit may be shared and performed by a plurality of devices or units. Alternatively, the processing described as being performed by different devices or units may be performed by a single device or unit. In a computer system, it is possible to flexibly change the hardware configuration that can achieve each function of the computer system.

In the above embodiments, the examples have been described in which the ECU 10 of the vehicle 1 functions as an information processing apparatus, but the present disclosure is not limited thereto. For example, a user's mobile terminal or an external server may function as an information processing apparatus.

The present disclosure can also be realized by supplying to a computer a computer program in which the functions described in the above embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. An in-vehicle system comprising a display device, and an information processing apparatus configured to output information via the display device,
the display device comprising a pair of display units that are provided in a forward portion of a driver's seat in a passenger compartment of a vehicle, are disposed at positions on both sides of a steering wheel while protruding rearward of an instrument unit disposed in front of the steering wheel, and have touch panels,
the information processing apparatus comprising a controller configured to execute:
turning off screens of the pair of display units in response to a predetermined condition being satisfied;
detecting a line-of-sight direction of a driver of the vehicle by a sensor when the screens of the pair of display units are turned off;
identifying a first display unit located in the line-of-sight direction of the driver of the vehicle from among the pair of display units whose screens are turned off; and
outputting information for activating a screen of the first display unit to the display device.

2. An in-vehicle system comprising a display device, and an information processing apparatus configured to output information via the display device,
the display device comprising a pair of display units that are provided in a forward portion of a driver's seat in a passenger compartment of a vehicle, are disposed at positions on both sides of a steering wheel while protruding rearward of an instrument unit disposed in front of the steering wheel, and have touch panels,
the information processing apparatus comprising a controller configured to execute:
turning off screens of the pair of display units in response to a predetermined condition being satisfied; and
outputting, to the display device, information for activating a screen of a first display unit corresponding to a line-of-sight direction of a driver of the vehicle among the pair of display units whose screens are turned off.

3. The in-vehicle system according to claim 2, wherein the pair of display units are disposed on a vehicle front side of a grip portion of the steering wheel in a front and rear direction of the vehicle.

4. The in-vehicle system according to claim 2, wherein the information processing apparatus comprises a storage configured to store information about screens displayed immediately before the screens of the pair of display units are turned off, in response to the predetermined condition being satisfied.

5. The in-vehicle system according to claim 2, wherein the controller is configured to set contents to be displayed on the screen of the first display unit according to a predetermined display condition, when outputting the information for activating the screen of the first display unit.

6. The in-vehicle system according to claim 5, wherein the predetermined display condition includes a condition outside the vehicle or a condition related to traveling of the vehicle.

7. The in-vehicle system according to claim 2, wherein the controller is configured to output, to the display device, a command to display a setting screen for headlights on the screen of the first display unit, when an illuminance outside the vehicle is less than a predetermined illuminance at the time of activating the screen of the first display unit.

8. The in-vehicle system according to claim 2, wherein the controller is configured to output, to the display device, a command to display a setting screen for wipers on the screen of the first display unit, when it is raining at the time of actuating the screen of the first display unit.

9. The in-vehicle system according to claim 2, wherein the controller is configured to output, to the display device, a command to display a screen with a smaller amount of information at the time of actuating the screen of the first display unit, when a speed of the vehicle is high than when it is low.

10. An information processing apparatus configured to output information via a display device,
the display device comprising a pair of display units that are provided in a forward portion of a driver's seat in a passenger compartment of a vehicle, are disposed at positions on both sides of a steering wheel while protruding rearward of an instrument unit disposed in front of the steering wheel, and have touch panels,
the information processing apparatus comprising a controller configured to execute:
turning off screens of the pair of display units in response to a predetermined condition being satisfied; and
outputting, to the display device, information for activating a screen of a first display unit corresponding to a line-of-sight direction of a driver of the vehicle among the pair of display units whose screens are turned off.

11. The information processing apparatus according to claim 10, wherein the pair of display units are disposed on a vehicle front side of a grip portion of the steering wheel in a front and rear direction of the vehicle.

12. The information processing apparatus according to claim 10, wherein the information processing apparatus comprises a storage configured to store information about screens displayed immediately before the screens of the pair of display units are turned off, in response to the predetermined condition being satisfied.

13. The information processing apparatus according to claim 10, wherein the controller is configured to set contents to be displayed on the screen of the first display unit according to a predetermined display condition, when outputting the information for activating the screen of the first display unit.

14. The information processing apparatus according to claim 13, wherein the predetermined display condition includes a condition outside the vehicle or a condition related to traveling of the vehicle.

15. The information processing apparatus according to claim 10, wherein the controller is configured to output, to the display device, a command to display a setting screen for headlights on the screen of the first display unit, when an illuminance outside the vehicle is less than a predetermined illuminance at the time of activating the screen of the first display unit.

16. The information processing apparatus according to claim 10, wherein the controller is configured to output, to the display device, a command to display a setting screen for wipers on the screen of the first display unit, when it is raining at the time of actuating the screen of the first display unit.

17. The information processing apparatus according to claim 10, wherein the controller is configured to output, to the display device, a command to display a screen with a smaller amount of information at the time of actuating the screen of the first display unit, when a speed of the vehicle is high than when it is low.
